(19) United States
(12) Patent Application Publication
(10) Pub. No.: US 2015/0249246 A1
(43) Pub. Date: Sep. 3, 2015

(54) BATTERY PACK

(71) Applicant: Samsung SDl Co., Ltd., Yongin-si (KR)

(72) Inventor: Bo-Hyun Byun, Yongin-si (KR)

(21) Appl. No.: 14/602,123

(22) Filed: Jan. 21, 2015

(30) Foreign Application Priority Data
Mar. 3, 2014 (KR) 10-2014-0024949

(51) Int. Cl. H01M 2/34; H01M 2/02; H01M 2/26; H01M 10/48

(52) U.S. Cl. CPC H01M 2/348; H01M 10/486; H01M 2/0202; H01M 2/26; H01M 2200/10; H01M 2220/30

(57) ABSTRACT

A battery pack is disclosed. In one aspect, the battery pack comprises a unit cell having an upper surface, a protection circuit module electrically connected to the unit cell, and a connector interposed between and electrically connected to the upper surface and the protection circuit module. The connector comprises a body unit and a first lead including a first protrusion unit protruding towards the protection circuit module from a first surface of the body unit.

### RELATED APPLICATIONS

This application claims the benefit of Korean Patent Application No. 10-2014-0024949, filed on Mar. 3, 2014, in the Korean Intellectual Property Office, the disclosure of which is incorporated herein in its entirety by reference.

### BACKGROUND

1. Field

The described technology generally relates to battery packs.

2. Description of the Related Technology

As wireless and communication technology continues to be developed, mobile electronic device that can be operated with a battery (i.e., without a power supply) is also being developed. Laptop computers are small in size and portable and thus, are being widely adopted for business or personal use for their excellent mobility. can In order to provide sufficient power to the laptop computer, the battery pack can include at least one battery cell that can be repeatedly charged and discharged.

### SUMMARY OF CERTAIN INVENTIVE ASPECTS

One inventive aspect is a battery pack.

Another aspect is a battery pack which includes: a unit cell that includes an electrode pin formed on an upper surface of the unit cell; a protection circuit module that is electrically connected to the unit cell and is placed on the upper surface of the unit cell; and a temperature-sensing element that is interposed between the upper surface of the unit cell and the protection circuit module, is electrically connected to the unit cell and the protection circuit module, and includes a body unit, a first lead connected to a first surface of the body unit, and a second lead connected to a second surface of the body unit, wherein the first lead includes a first protrusion unit that protrudes towards the protection circuit module to support the protection circuit module.

The first surface of the body unit can be a surface facing the protection circuit module and the first lead can be connected to the first surface of the body unit and the protection circuit module.

The first protrusion unit can be placed on an edge of the first lead adjacent to the electrode pin.

The protection circuit module can include a circuit substrate and protection devices placed on a region of the lower surface of the circuit substrate facing the upper surface of the unit cell.

The first protrusion unit can contact the lower surface of the circuit substrate.

The first lead can be connected to the first surface of the body unit and the protection circuit module, and can extend in a direction away from the protection devices, and the second lead can be connected to the second surface of the body unit and the electrode pin, and can extend in a direction towards the protection devices.

The second lead can include a second protrusion unit that protrudes towards the protection circuit module so that the protection devices are spatially separated from the temperature-sensing element.

The second protrusion unit can be placed on an edge unit of the second lead adjacent to the protection devices.

The unit cell can include: a can that includes an opening; an electrode assembly that is accommodated in the can through the opening, and includes a first electrode plate having a first polarity, a second electrode plate having a second polarity, and a separator that is interposed between the first and second electrode plates; a cap plate that seals the opening; and an electrode pin that extends upwards from the cap plate.

The electrode pin can have a first polarity and the cap plate can have a second polarity that is different from the first polarity.

The battery pack can further include an insulating film interposed between the temperature-sensing element and the cap plate.

The battery pack can further include a metal member interposed between the first lead and the protection circuit module.

A height of the first protrusion unit can be substantially the same as the thickness of the metal member.

A portion of the first lead that is connected to the protection circuit module can be bent to have a step difference substantially the same as the height of the first protrusion unit.

Another aspect is a battery pack which includes: a unit cell that includes an electrode pin formed on an upper surface of the unit cell; a protection circuit module that is electrically connected to the unit cell, is placed on the upper surface of the unit cell, includes a circuit substrate that includes a hole formed on a location corresponding to the electrode pin, and protection devices formed on the circuit substrate; and a temperature-sensing element that is interposed between the upper surface of the unit cell and the circuit substrate, and includes a body unit, a first lead that is connected to the body unit and the electrode pin, and a second lead that is connected to the body unit and the protection circuit module, wherein the circuit substrate includes a first region and a second region that are provided on both sides of the hole, the temperature-sensing element is placed on the first region of the circuit substrate and the protection devices are placed on the second region of the circuit substrate, and an edge of the first lead is bent towards the circuit substrate to support the circuit substrate of the protection circuit module.

An edge of the first lead can be connected to the body unit, and the other edge of the first lead can be connected to the circuit substrate of the protection circuit module.

An edge of the second lead can be connected to the body unit and the other edge of the second lead can be connected to the electrode pin of the unit cell.

The second lead can include a second protrusion unit that spatially separates the protection devices placed on the first region of the circuit substrate from a connection surface of the second lead that is connected to the electrode pin.

The second protrusion unit can be formed by bending the other edge of the second lead.

The second protrusion unit can be bent towards the circuit substrate.

Another aspect is a battery pack comprising a unit cell, a protection circuit module, and a temperature-sensing element. The unit cell includes an electrode pin formed on an upper surface of the unit cell. The protection circuit module is electrically connected to the unit cell and placed over the upper surface of the unit cell. The temperature-sensing element is i) interposed between the upper surface and the protection circuit module, ii) electrically connected to the unit cell and the protection circuit module, and iii) comprising a body unit, a first lead connected to a first surface of the body unit, and a second lead connected to a second surface of the body unit. The first lead comprises a first protrusion unit that protrudes towards the protection circuit module. The temperature-sensing element is configured to electrically connect the first and second leads so as to provide current flow when the temperature of the body unit is below a threshold and electrically disconnect the first and second leads so as to block the current flow when the temperature is above the threshold.

In the above battery pack, the first surface faces the protection circuit module, wherein the first lead is connected to the first surface and the protection circuit module.

In the above battery pack, the first protrusion unit is placed on an edge of the first lead adjacent to the electrode pin.

In the above battery pack, the protection circuit module comprises a circuit substrate and at least one protection device placed over a region of a lower surface of the circuit substrate facing the upper surface of the unit cell. In the above battery pack, the first protrusion unit is connected to the lower surface of the circuit substrate.

In the above battery pack, the first lead is connected to the first surface of the body unit and the protection circuit module, wherein the first lead extends in a direction away from the protection device, wherein the second lead is connected to the second surface of the body unit and the electrode pin, and wherein the second lead extends in a direction towards the protection device.

In the above battery pack, the second lead comprises a second protrusion unit that protrudes towards the protection circuit module so that the protection device is spatially separated from the temperature-sensing element. In the above battery pack, the second protrusion unit is placed over an edge of the second lead adjacent to the protection device.

In the above battery pack, the unit cell comprises a container having an opening, an electrode assembly, a cap plate, and an electrode pin. The electrode assembly is accommodated in the container and comprises i) a first electrode plate having a first polarity, ii) a second electrode plate having a second polarity, and iii) a separator interposed between the first and second electrode plates. The cap plate is configured to substantially seal the opening. The electrode pin extends upwards from the cap plate.

In the above battery pack, the electrode pin has a first polarity, wherein the cap plate has a second polarity different from the first polarity. The above battery pack further comprises an insulating film interposed between the temperature-sensing element and the cap plate.

The above battery pack further comprises a metal member interposed between the first lead and the protection circuit module. In the above battery pack, the height of the first protrusion unit is substantially the same as the thickness of the metal member.

In the above battery pack, a portion of the first lead is bent so as to have a step difference substantially the same as the height of the first protrusion unit.

Another aspect is a battery pack comprising a unit cell, a protection circuit module, and a temperature-sensing element. The unit cell includes an electrode pin formed over an upper surface of the unit cell. The protection circuit module is electrically connected to the unit cell and placed over the upper surface of the unit cell, wherein the protection circuit module comprises i) a circuit substrate having a hole formed in a location corresponding to the electrode pin and ii) at least one protection device placed over the circuit substrate. The temperature-sensing element is interposed between the upper surface of the unit cell and the circuit substrate, wherein the temperature-sensing element comprises i) a body unit, ii) a first lead connected to the body unit and the electrode pin, and iii) a second lead connected to the body unit and the protection circuit module. The circuit substrate comprises a first region and a second region on opposing sides of the hole. The temperature-sensing element is placed in the first region and the protection device is placed in the second region. An edge of the first lead is bent towards the circuit substrate.

In the above battery pack, a first edge of the first lead is connected to the body unit, wherein a second edge of the first lead is connected to the circuit substrate.

In the above battery pack, a first edge of the second lead is connected to the body unit, wherein a second edge of the second lead is connected to the electrode pin. In the above battery pack, the second lead comprises a second protrusion unit separating the protection device placed in the first region from a connection surface of the second lead connected to the electrode pin. In the above battery pack, the second edge of the second lead is bent so as to form the second protrusion unit.

In the above battery pack, the second protrusion unit is bent towards the circuit substrate.

Another aspect is a battery pack comprising a unit cell having an upper surface, a protection circuit module electrically connected to the unit cell, and a temperature-sensing element interposed between and electrically connected to the upper surface and the protection circuit module. The temperature-sensing element comprises a body unit and a first lead including a first protrusion unit protruding towards the protection circuit module from a first surface of the body unit.

In the above battery pack, the temperature-sensing element further comprises a second lead connected to a second surface of the body unit. In the above battery pack, the temperature-sensing element is configured to electrically connect the first and second leads so as to provide current flow when the temperature of the body unit is below a threshold and electrically disconnect the first and second leads so as to block the current flow when the temperature is above the threshold.

### BRIEF DESCRIPTION OF THE DRAWINGS

FIG. 1 is an exploded perspective view of a battery pack according to an embodiment.

FIG. 2 is an exploded perspective view of a battery pack of FIG. 1.

FIG. 3 is a front view of a portion of the battery pack of FIG. 1.

FIG. 4 is an extracted perspective view of a temperature-sensing element of FIG. 1.

FIG. 5 is an extracted front view of the temperature-sensing element of FIG. 1.

FIG. 6 is an extracted front view of a region IV of FIG. 3.

FIG. 7 is a perspective view of a temperature-sensing element according to another embodiment.

FIG. 8 is a front view of the temperature-sensing element of FIG. 7.

FIG. 9 is a front view of a portion of a battery pack of FIG. 7.

FIG. 10 is an extracted front view of a region X of FIG. 9.

### DETAILED DESCRIPTION OF CERTAIN INVENTIVE EMBODIMENTS

The described technology can be modified into various forms and can have various embodiments. In this regard, the described technology will now be made in detail to embodiments, examples of which are illustrated in the accompanying drawings. The advantages, features, and methods of achieving the advantages can be clear when referring to the embodiments described below together with the drawings. However, the described technology can have different forms and should not be construed as being limited to the descriptions set forth herein.

Hereafter, the described technology will be described more fully with reference to the accompanying drawings, in which exemplary embodiments of the described technology are shown. In describing the described technology with reference to drawings, like reference numerals are used for elements that are substantially identical or correspond to each other, and the descriptions thereof will not be repeated.

It will be understood that, although the terms “first”, “second”, “third”, etc., can be used herein to describe various elements, these elements should not be limited by these terms. These terms are only used to distinguish one element from another.

In the following embodiments, the singular forms include the plural forms unless the context clearly indicates otherwise.

In the following embodiments, it will be understood that the terms “comprise” and/or “comprising,” when used in this specification, specify the presence of stated features, and/or components, but do not preclude the presence or addition of one or more other features, and/or components, and/or groups thereof.

It will be understood that when an element or layer is referred to as being “on” another element or layer, the element or layer can be directly on another element or layer or intervening elements or layers.

In the following embodiments, the x axis, y axis, and z axis are not limited to three axis on a coordinate system, but can be interpreted in a broad sense. For example, the x axis, y axis, and z axis can perpendicularly cross each other but can indicate in different directions that do not perpendicularly cross each other.

In the drawings, lengths and sizes of layers and regions can be exaggerated reduced for convenience of explanation. For example, sizes and thicknesses shown in the drawings are arbitrary shown for convenience of explanation, the described technology is not necessarily limited thereto. In this disclosure, the term “substantially” includes the meanings of completely, almost completely or to any significant degree under some applications and in accordance with those skilled in the art. Moreover, “formed on” can also mean “formed over.”

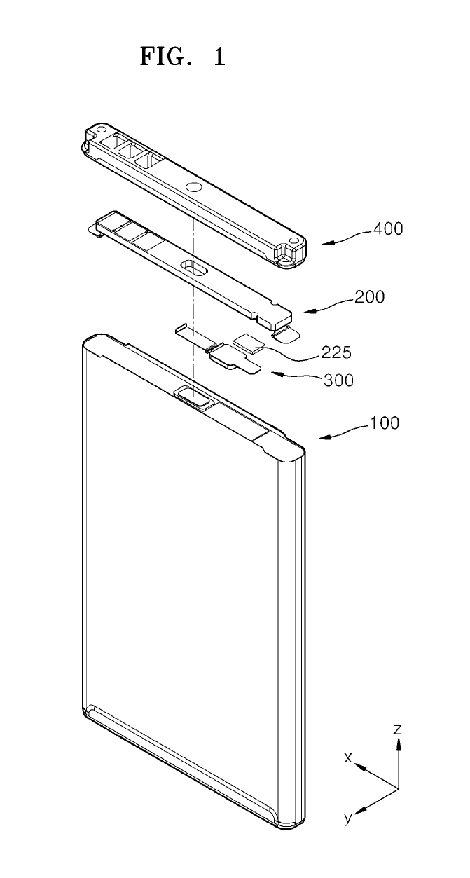

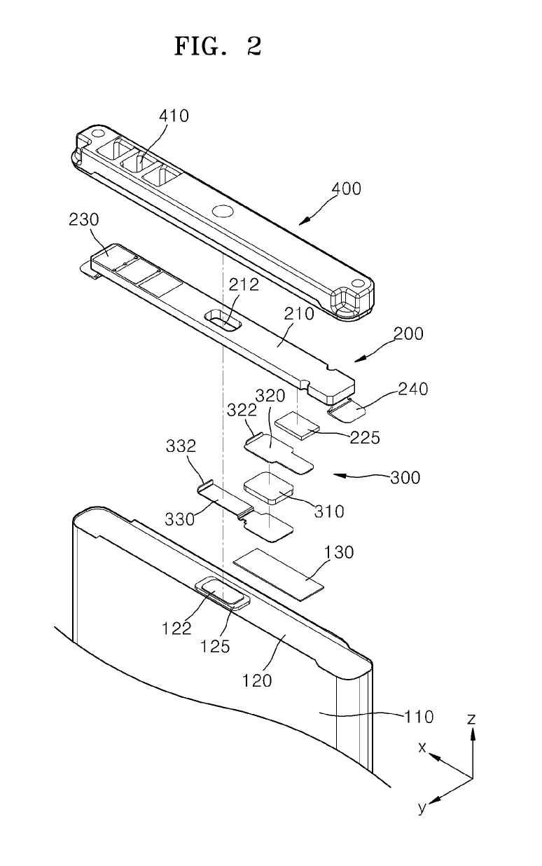

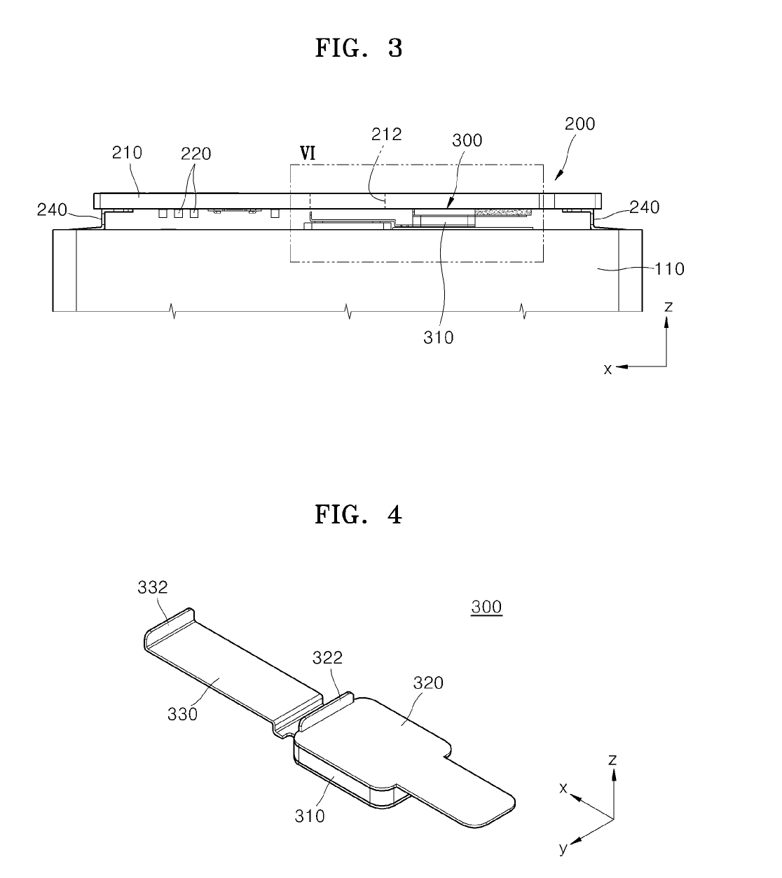

FIG. 1 is an exploded perspective view of a battery pack according to an embodiment. FIG. 2 is an exploded perspective view of a battery pack of FIG. 1. FIG. 3 is a schematic front view of a portion of the battery pack of FIG. 1.

Referring to FIGS. 1 through 3, the battery pack can include a unit cell 100, a protection circuit module 200 that is electrically connected to the unit cell 100, a temperature-sensing element or a connector 300 interposed between the unit cell 100 and the protection circuit module 200, and an upper cover 400.

The unit cell 100 can include a container 110 that can include an opening, an electrode assembly that can be accommodated in the can 110 through the opening, a cap plate 120 that can seal the opening of the container 110, an electrode pin 122 formed on the cap plate 120, an insulating film 130 placed on the cap plate 120, and a connection member 240. The unit cell 100 is a rechargeable secondary battery and can be formed of a lithium-ion battery.

The container 110 can have an approximately hexahedron shape, an upper surface of which is opened, and can be formed of a metal material to ensure strength. For example, the container 110 can be formed of aluminum or an alloy of aluminum. After the electrode assembly is inserted into the container 110 through the opening, the opening can be sealed by the cap plate 120. The cap plate 120, like the container 110, can be formed of a metal material, such as aluminum or an alloy of aluminum. A portion where the cap plate 120 contacts the container 110 can be combined and shut by laser welding, and thus, the inside of the container 110 can be airtight.

The electrode assembly can include first and second electrode plates on which an active material is coated and a separator interposed between the first and second electrode plates. The first and second electrode plates can have different polarities. The electrode assembly can be manufactured by winding the first electrode plate, the separator, and the second electrode plate in a jelly-roll form after the first electrode plate, the separator, and the second electrode plate have been sequentially stacked. In some embodiments, the electrode assembly can be a stack-type electrode assembly in which a first electrode plate, a separator, and a second electrode plate are sequentially stacked.

The cap plate 120 can be placed on an upper surface of the container 110 to seal the opening of the container 110. The electrode pin 122 is placed on the cap plate 120. The first electrode plate can be electrically connected to the cap plate 120, and the second electrode plate can be electrically connected to the electrode pin 122. Because the first and second electrode plates have different polarities, the cap plate 120 and the electrode pin 122 have different polarities. For example, the cap plate 120 can have a positive polarity and the electrode pin 122 can have a negative polarity. In some embodiments, in order to prevent a short circuit between the cap plate 120 and the electrode pin 122, a gasket 125 can be included between the electrode pin 122 and the cap plate 120. The gasket 125 can be formed of an insulating material and can prevent a short circuit between the cap plate 120 and the electrode pin 122.

The insulating film 130 can be placed on the cap plate 120. The temperature-sensing element 300 can be placed on the insulating film 130. Because the insulating film 130 is interposed between the cap plate 120 and the temperature-sensing element 300, a short circuit therebetween can be prevented. For example, when the temperature-sensing element 300 that is connected to the electrode pin 122 is placed on the cap plate 120, a short circuit can occur between the temperature-sensing element 300 and the cap plate 120 because the polarities of the temperature-sensing element 300 and the cap plate 120 are different. However, because the insulating film 130 can be placed between the temperature-sensing element 300 and the cap plate 120, a short circuit therebetween can be prevented.

Referring to FIGS. 2 and 3, the protection circuit module 200 is placed on the upper surface of the unit cell 100 The protection circuit module 200 is electrically connected to the unit cell 100 so as to control charge and discharge of the unit cell 100. The protection circuit module 200 can prevent the unit cell 100 from overheating or an explosion that can occur due to an over-charge, an over-discharge, or an over-current.

The protection circuit module 200 can include a circuit substrate 210, protection devices 220 mounted on the circuit substrate 210, and external terminals 230. The circuit substrate 210 can be formed of a resin having a plate shape. The circuit substrate 210 is electrically connected to the cap plate 120 through the connection members 240 placed on both lower edges or opposing ends of the circuit substrate 210. The circuit substrate 210 can be separately placed with a predetermined gap from the cap plate 120. The circuit substrate 210 can have a hole 212 in substantially the center thereof. The hole 212 can be formed in a location corresponding to the electrode pin 122. The hole 212 is formed so as to weld the electrode pin 122 to the temperature-sensing element 300 when the protection circuit module 200 is combined with the unit cell 100.

The protection devices 220 can be placed on a side of a lower surface of the circuit substrate 210 that faces the upper surface of the unit cell 100. More specifically, the protection devices 220 can be placed on a first side of the circuit substrate 210 with the hole 212 as substantially the center. The first side can be an opposite side to a second side where the temperature-sensing element 300 is placed. The protection devices 220 are placed in plural and can form a circuit to control charge and discharge of batteries. In FIG. 3, the protection devices 220 are placed on the lower surface of the circuit substrate 210, but are not limited thereto, and the protection devices 220 can be placed on an upper surface of the circuit substrate 210.

The external terminals 230 can be placed on an upper side surface of the circuit substrate 210. That is, the external terminals 230 can be placed on the first side of the circuit substrate 210 where the protection devices 220 are placed. The external terminals 230 are terminals for connecting the protection circuit module 200 to external electronic devices (not shown), and are placed on the upper surface of the circuit substrate 210 so as to be exposed to the outside.

The connection members 240 can be placed on both edges or opposing ends of the protection circuit module 200. The connection members 240 are attached to the both edges of a lower surface of the protection circuit module 200 and are bent towards an opposite direction to the direction in which the hole 212 is placed. The connection members 240 contact the cap plate 120, and the protection circuit module 200 can be separately formed from the cap plate 120 by a distance that is as much as a height of the bent part of the connection members 240. In a space that is formed by separating the protection circuit module 200 from the cap plate 120, the temperature-sensing element 300 and the protection devices 220 can be placed. As described above, the connection members 240 contact the cap plate 120, and thus, the protection circuit module 200 can be electrically connected to the cap plate 120. More specifically, one of the connection members 240 placed on the both edges of the protection circuit module 200 electrically connects the protection circuit module 200 to the cap plate 120, and the other one of the connection members 240 is a dummy connection member so as to balance the circuit substrate 210.

The protection circuit module 200 can further include a metal member 225 that is placed on the lower surface of the circuit substrate 210. The metal member 225 can be placed in a direction opposite to the direction in which a protection circuit is placed. The metal member 225 can be formed of nickel. The metal member 225 can electrically connect the temperature-sensing element 300 to the protection circuit module 200 by contacting a first lead 320 of the temperature-sensing element 300, which will be described below. The upper cover 400 can have an inner space having a size that is enough to accommodate the protection circuit module 200 therein, and a lower side thereof is opened. Terminal holes 410 are formed in a side of the upper cover 400 so as to expose the external terminals 230 to the outside.

The temperature-sensing element 300 is interposed between the upper surface of the unit cell 100 and the protection circuit module 200, and can be electrically connected to the unit cell 100 and the protection circuit module 200. The temperature-sensing element 300 can be placed on the other side of the cap plate 120. As described above, the temperature-sensing element 300 can be placed on the second side with the hole 212 as substantially the center, and the second side is substantially opposite to the first side on which the protection devices 220 are placed.

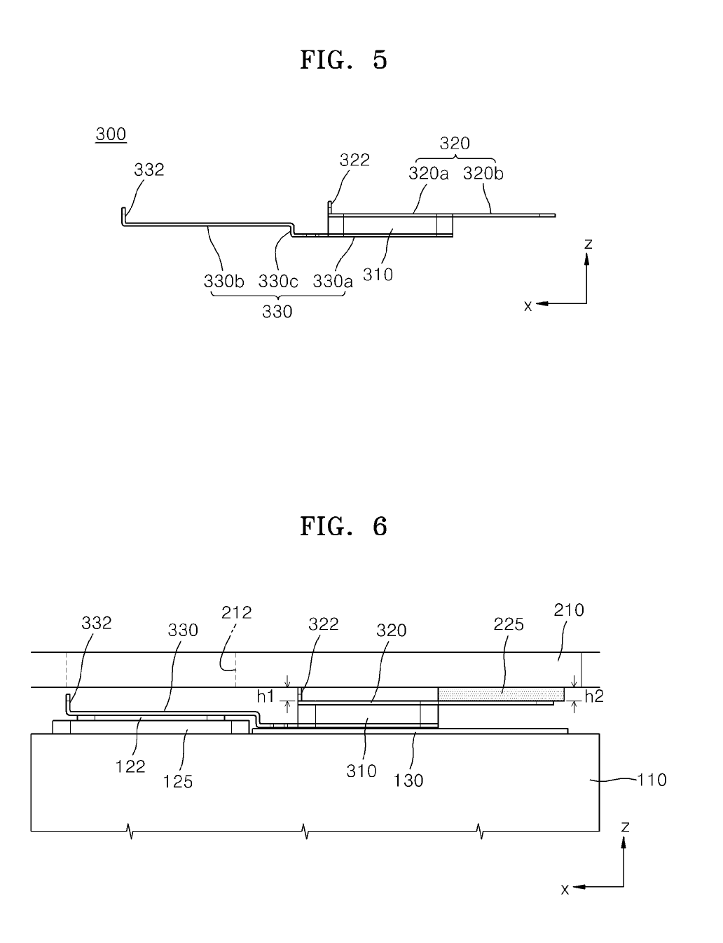

An embodiment and function of the temperature-sensing element 300 will be described with reference to FIGS. 4 and 5.

FIG. 4 is an extracted perspective view of the temperature-sensing element 300 of FIG. 1. FIG. 5 is an extracted front view of the temperature-sensing element 300 of FIG. 1.

Referring to FIGS. 4 and 5, the temperature-sensing element 300 include a body unit 310, the first lead 320, and a second lead 330. The first lead 320 can be placed relatively farther from the protection devices 220 and the second lead 330 can be placed restively closer to the protection devices 220. The first lead 320 and the second lead 330 respectively can have a first protrusion unit 322 and a second protrusion unit 332.

The body unit 310 can be formed by distributing conductive particles in a crystalline polymer. In some embodiments, the conductive particles can be carbon particles, and the crystalline polymer can be a synthetic resin, such as polyolefin group resin. The body unit 310 can connect a flow of current between the first and second leads 320 and 330 because the conductive particles are agglomerated at a temperature below a set point. However, when the temperature is above the set point, the conductive particles are separated due to the expansion of the crystalline polymer, which results in rapid increase in resistance. Thus, a current flow between the first and second leads 320 and 330 is blocked or is very low. Accordingly, the body unit 310 can function as a safety device for preventing a breakage of a battery by being electrically connected to the battery. In some embodiments, the temperature of the body unit 310 becomes higher than the set point when heat is generated due to overcharge of the battery. When the temperature is cooled to below the set point, the crystalline polymer contracts and the conductive particles are re-connected, and thus, the current flow is resumed.

Referring to FIG. 5, the first lead 320 includes a first conductive unit 320a that is connected to a first surface of the body unit 310 and a second conductive unit 320b that is connected to the protection circuit module 200. The first surface of the body unit 310 can denote an upper surface of the body unit 310 that faces the protection circuit module 200. That is, the first and second conductive units 320a and 320b are substantially parallel to each other. Also, the second conductive unit 320b can be combined with a lower surface of the protection circuit module 200 by being welded to the protection circuit module 200.

The first lead 320 can include the first protrusion unit 322 that protrudes towards the protection circuit module 200. For example, the first lead 320 and the first protrusion unit 322 can be substantially perpendicular to each other. The first protrusion unit 322 can be formed by bending an edge of the first conductive unit 320a of the first lead 320.

Referring to FIG. 5, the second lead 330 includes a first conductive unit 330a that is connected to a second surface of the body unit 310, a second conductive unit 330b that is connected to the electrode pin 122 of the unit cell 100, and a connection unit 330c that connects the first conductive unit 330a to the second conductive unit 330b. The second surface can denote a lower surface of the body unit 310 that is connected to the cap plate 120. The first and second conductive units 330a and 330b are formed substantially parallel to each other. The connection unit 330c is formed substantially perpendicular to the first and second conductive units 330a and 330b so that the first and second conductive units 330a and 330b have a step difference. Also, the second conductive unit 330b can be formed on a location corresponding to the hole 212. Accordingly, the second conductive unit 330b can be welded to the electrode pin 122 through the hole 212 of the circuit substrate 210.

The second lead 330 can include the second protrusion unit 332 that protrudes towards the protection circuit module 200. For example, the second lead 330 and the second protrusion unit 332 can be formed substantially perpendicular to each other or can be modified in various forms. The second protrusion unit 332 can be formed by bending an edge of the second conductive unit 330b.

FIG. 6 is an extracted front view of a region IV of FIG. 3.

Referring to FIG. 6, as described above, the cap plate 120 and the protection circuit module 200 are connected through the connection members 240, and thus, the cap plate 120 and the protection circuit module 200 are separated by a predetermined distance. With the electrode pin 122 formed on a location corresponding to the hole 212 as substantially the center, the temperature-sensing element 300 can be placed on the first side and the protection devices 220 can be placed on the second side.

The temperature-sensing element 300 can be placed on the cap plate 120, and the insulating film 130 can be interposed between the temperature-sensing element 300 and the cap plate 120 so as to prevent a short circuit therebetween. As described above, the first lead 320 is connected to the first surface, which is the upper surface of the body unit 310, and the second lead 330 is connected to the second surface, which is the lower surface of the body unit 310. The first lead 320 and the second lead 330 can extend in substantially opposite directions. The second lead 330 can extend in a second side direction in which the protection devices 220 are placed, and the first lead 320 can extend in a first side direction which is opposite to the second side direction.

An edge of the first lead 320 can be connected to a first surface of the body unit 310, and the other edge of the first lead 320 can be connected to the protection circuit module 200. The other edge of the first lead 320 can denote a portion of the first lead 320 that is not connected to the first surface of the body unit 310. The other edge of the first lead 320 can be connected to the metal member 225 placed on a lower side of the circuit substrate 210. More specifically, the other edge of the first lead 320 can be connected to a lower surface of the metal member 225 that faces the upper surface of the unit cell 100.

The first lead 320 can include the first protrusion unit 322 that protrudes towards the protection circuit module 200, and the first protrusion unit 322 can be placed on an edge unit adjacent to the electrode pin 122 of the first lead 320. For example, the first lead 320 and the first protrusion unit 322 can be substantially perpendicularly formed and can form a substantially “L” shape. As depicted in FIG. 6, an edge unit of the first protrusion unit 322 contacts the lower surface of the circuit substrate 210. Accordingly, a height h1 of the first protrusion unit 322 can be substantially the same as the thickness h2 of the metal member 225.

Because the edge unit of the first protrusion unit 322 contacts the lower surface of the circuit substrate 210, the first protrusion unit 322 can support the lower side of the protection circuit module 200. The protection circuit module 200 is formed along a length direction of the unit cell 100 and is supported by the connection members 240 placed on both edges thereof, and thus, a central portion of the circuit substrate 210 is not sagged or deformed. When the central portion of the circuit substrate 210 sags towards the cap plate 120, which can be the gravitational direction, there is a possibility that the temperature-sensing element 300 placed on the cap plate 120 can be damaged. Accordingly, a sagging phenomenon of the central portion of the circuit substrate 210 can be prevented by forming the first protrusion unit 322 on an edge of the first lead 320.

An edge of the second lead 330 can be connected to the first surface of the body unit 310, and the other edge of the second lead 330 can be connected to the electrode pin 122. The other edge of the second lead 330 can denote a portion of the second lead 330 that is not connected to the second surface of the body unit 310.

As described above, the second lead 330 can extend in the second side direction and can include the second protrusion unit 332. The second protrusion unit 332 can be placed on an edge of the second lead 330 adjacent to the protection devices 220, and can be formed in a bending shape by bending an edge unit that extends in the second side direction of the second lead 330. For example, the second lead 330 and the second protrusion unit 332 can be substantially perpendicular to each other. The protection devices 220 and the temperature-sensing element 300 that are interposed between the cap plate 120 and the protection circuit module 200 with the second protrusion unit 332 as substantially the center can be spatially separated.

In typical devices, the protection devices 220 and the temperature-sensing element 300 are not spatially separated. Therefore, due to a dispersion of bun that occurs when the temperature-sensing element 300 is welded on the electrode pin 122, there can be a short circuit between various devices, such as the protection devices 220 placed on the circuit substrate 210. In order to prevent this problem, the second protrusion unit 332 can placed on the edge of the second lead 330 adjacent to the protection devices 220. Thus, without installing an additional structure, the dispersion of bun can be reduced, and accordingly, a short circuit can be prevented.

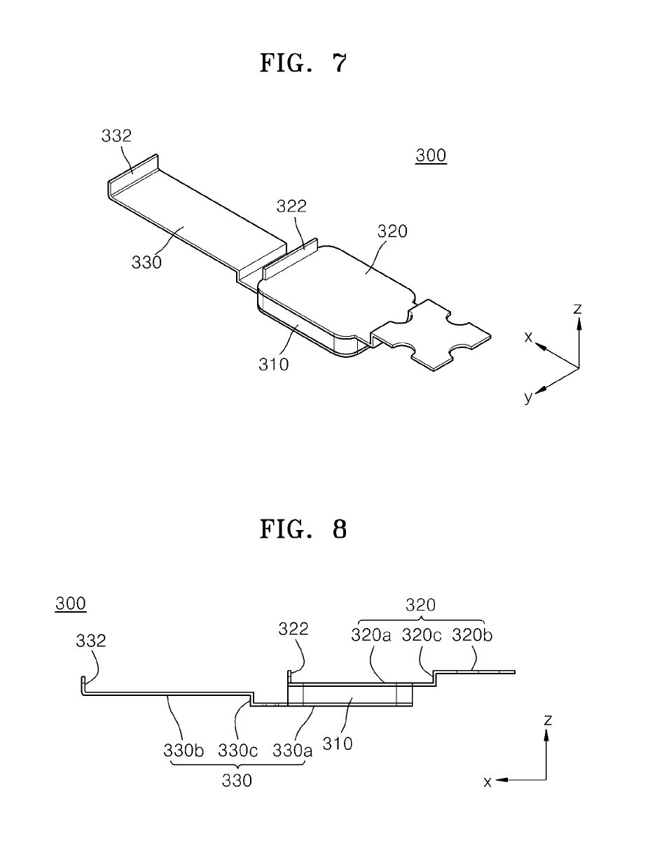

FIG. 7 is a perspective view of a temperature-sensing element 300 according to another embodiment. FIG. 8 is a front view of the temperature-sensing element 300 of FIG. 7. Descriptions of the same elements already described with reference to previous figures are omitted, except for that of the temperature-sensing element 300.

Referring to FIGS. 7 and 8, the temperature-sensing element 300 can include a body unit 310, a first lead 320, and a second lead 330. The first lead 320 is placed relatively away from the protection devices 220, and the second lead 330 is placed relatively close to the protection devices 220. The first lead 320 and the second lead 330 respectively can have a first protrusion unit 322 and a second protrusion unit 332.

Referring to FIG. 8, the first lead 320 includes a first conductive unit 320a that is connected to a first surface of the body unit 310, a second conductive unit 320b that is connected to the protection circuit module 200, and a connection unit 320c that connects the first conductive unit 320a and the second conductive unit 320b. The first surface of the body unit 310 can denote an upper surface of the body unit 310 facing the protection circuit module 200. The connection unit 320c is formed substantially perpendicular to the first and second conductive units 320a and 320b so that the first and second conductive units 320a and 320b have a step difference. That is, the first and second conductive units 320a and 320b are formed substantially parallel to each other, and the connection unit 320c is formed substantially perpendicular to the first and second conductive units 320 and 320b. Also, the second conductive unit 320b is combined with a lower surface of the protection circuit module 200 by being welded to the protection circuit module 200.

The first lead 320 can include a first protrusion unit 322 that protrudes towards the protection circuit module 200. For example, the first lead 320 and the first protrusion unit 322 can be formed substantially perpendicular to each other or can be modified in various ways. The first protrusion unit 322 can be formed by bending an edge of the first lead 320.

Referring to FIG. 8, the second lead 330 can include a first conductive unit 330a that is connected to a second surface of the body unit 310, a second conductive unit 330b that is connected to the electrode pin 122, and a connection unit 330c that connects the first and second conductive units 330a and 330b. The second surface can denote a lower surface of the body unit 310. The connection unit 330c is formed substantially perpendicular to the first and second conductive units 330a and 330b so that the first and second conductive units 330a and 330b have a step difference. That is, the first and second conductive units 330a and 330b are formed substantially parallel to each other, and the connection unit 330c is formed substantially perpendicular to the first and second conductive units 330a and 330b. Also, the second conductive unit 330b is formed on a location corresponding to the hole 212 in the circuit substrate 210. Accordingly, the second conductive unit 330b can be welded to the electrode pin 122 through the hole 212.

The second lead 330 can include a second protrusion unit 332 that protrudes towards the protection circuit module 200. For example, the second lead 330 and the second protrusion unit 332 can be formed substantially perpendicular to each other. The second protrusion unit 332 can be formed by bending an edge of the second conductive unit 330b.

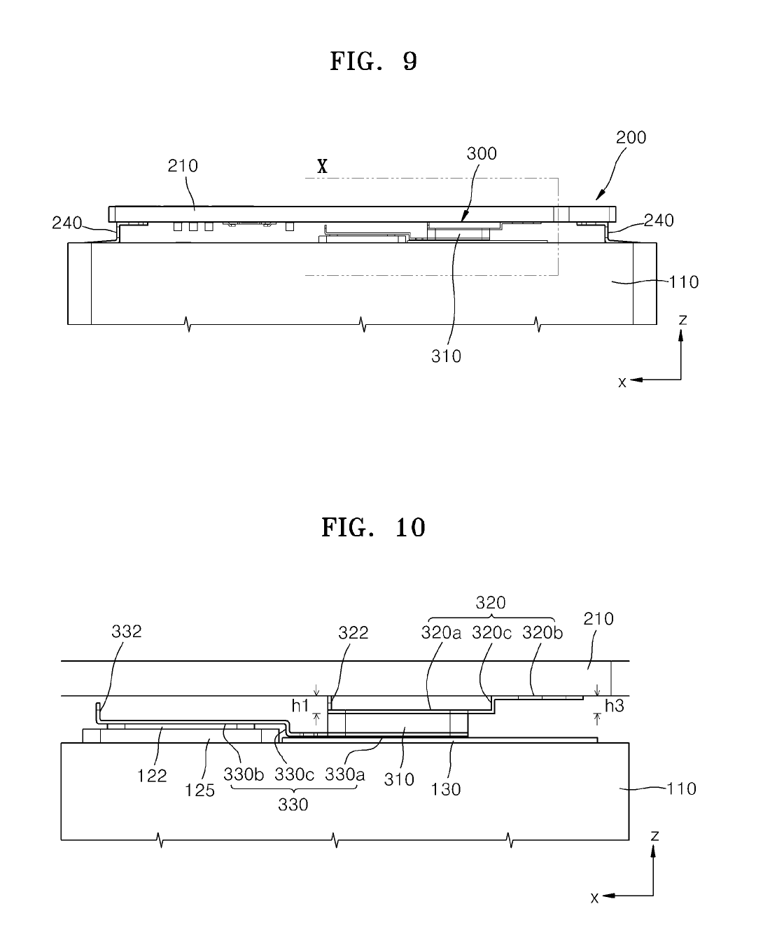

FIG. 9 is a schematic front view of a portion of a battery pack of FIG. 7. FIG. 10 is an extracted front view of a region X of FIG. 9.

Referring to FIGS. 9 and 10, as described above, the cap plate 120 and the protection circuit module 200 are connected through the connection members 240 by a predetermined separation distance. With the electrode pin 122 formed on a location corresponding to the hole 212 as substantially the center, the temperature-sensing element 300 can be placed on the first side and the protection devices 220 can be placed on the second side.

The temperature-sensing element 300 can be placed on the cap plate 120, and in order prevent a short circuit, an insulating film 130 can be interposed between the temperature-sensing element 300 and the cap plate 120. As described above, the first lead 320 can be connected to a first surface which is an upper surface of the body unit 310, and the second lead 330 can be connected to a second surface which is a lower surface of the body unit 310. The first lead 320 and the second lead 330 can extend in substantially opposite directions. The second lead 330 can extend in a second side direction in which the protection devices 220 are placed, and the first lead 320 can extend in a first side direction which is substantially opposite to the second side direction.

Referring to FIG. 10, the first conductive unit 320a can be connected to the first surface of the body unit 310, and the second conductive unit 320b can be connected to the protection circuit module 200. The second conductive unit 320b can contact a lower side of the circuit substrate 210.

The first lead 320 can include a first protrusion unit 322 that protrudes towards the protection circuit module 200, and the first protrusion unit 322 can be placed on an edge of the first lead 320 adjacent to the electrode pin 122. That is, the first protrusion unit 322 can be formed on an edge of the first conductive unit 320a. For example, the first lead 320 and the first protrusion unit 322 can be formed substantially perpendicular to each other, and the first conductive unit 320a and the first protrusion unit 322 can form a substantially “L” shape. As depicted in FIG. 10, an edge of the first protrusion unit 322 can contact the lower surface of the circuit substrate 210. Accordingly, a height h1 of the first protrusion unit 322 can be substantially the same as a height h3 of the connection unit 320c.

Because the edge of the first protrusion unit 322 contacts the lower surface of the circuit substrate 210, the first protrusion unit 322 can support the lower side of the protection circuit module 200. The protection circuit module 200 is formed along a length direction of the unit cell 100, and the protection circuit module 200 is supported by the connection members 240 placed on both edges or opposing ends of the protection circuit module 200, and thus a center portion of the circuit substrate 210 can sag or be deformed. When the central portion of the circuit substrate 210 sags towards the cap plate 120, which can be the gravitational direction, there is a possibility that the temperature-sensing element 300 placed on the cap plate 120 can be damaged. Accordingly, a sagging phenomenon of the central portion of the circuit substrate 210 can be prevented by forming the first protrusion unit 322 on an edge of the first lead 320.

A first conductive unit 330a can be connected to the first surface of the body unit 310, and a second conductive unit 330b can be connected to the electrode pin 122. The second conductive unit 330b can denote a portion of the second lead 330 that is not connected to the second surface of the body unit 310.

As described above, the second lead 330 can extend in the second side direction and can include the second protrusion unit 332 that protrudes towards the protection circuit module 200. The second protrusion unit 332 can be placed on an edge of the second lead 330 adjacent to the protection devices 220, and can be formed in a bending shape by bending an edge unit of the second conductive unit 330b. For example, the second lead 330 and the second protrusion unit 332 can be formed substantially perpendicular to each other, and the second conductive unit 330b and the second protrusion unit 332 can form an “L” shape. The protection devices 220 and the temperature-sensing element 300, that are interposed between the cap plate 120 and the protection circuit module 200 with the second protrusion unit 332 as substantially the center, can be spatially separated.

In typical devices, the protection devices 220 and the temperature-sensing element 300 are not spatially separated. Therefore, due to a dispersion of bun that occurs when the temperature-sensing element 300 is welded on the electrode pin 122, there can be a short circuit between various devices, such as the protection devices 220 placed on the circuit substrate 210. In order to prevent this problem, the second protrusion unit 332 is placed on the edge of the second lead 330 adjacent to the protection devices 220. Thus, without installing an additional structure, the dispersion of bun can be reduced, and accordingly, a short circuit can be prevented.

As described above, according to the embodiments, a battery pack having an improved durability and safety can be realized, but the advantages of the embodiments of the described technology are not limited thereto.

While the inventive technology has been described with reference to the figures, it will be understood by those of ordinary skill in the art that various changes in form and details can be made therein without departing from the spirit and scope of the present invention as defined by the following claims.

What is claimed is:

1. A battery pack, comprising:
a unit cell including an electrode pin formed on an upper surface of the unit cell;
a protection circuit module electrically connected to the unit cell and placed over the upper surface of the unit cell; and
a temperature-sensing element i) interposed between the upper surface and the protection circuit module, ii) electrically connected to the unit cell and the protection circuit module, and iii) comprising a body unit, a first lead connected to a first surface of the body unit, and a second lead connected to a second surface of the body unit, wherein the first lead comprises a first protrusion unit that protrudes towards the protection circuit module.

2. The battery pack of claim 1, wherein the first surface faces the protection circuit module, and wherein the first lead is connected to the first surface and the protection circuit module.

3. The battery pack of claim 1, wherein the first protrusion unit is placed on an edge of the first lead adjacent to the electrode pin.

4. The battery pack of claim 1, wherein the protection circuit module comprises a circuit substrate and at least one protection device placed over a region of a lower surface of the circuit substrate facing the upper surface of the unit cell.

5. The battery pack of claim 4, wherein the first protrusion unit is connected to the lower surface of the circuit substrate.

6. The battery pack of claim 4, wherein the first lead is connected to the first surface of the body unit and the protection circuit module, wherein the first lead extends in a direction away from the protection device, wherein the second lead is connected to the second surface of the body unit and the electrode pin, and wherein the second lead extends in a direction towards the protection device.

7. The battery pack of claim 4, wherein the second lead comprises a second protrusion unit that protrudes towards the protection circuit module so that the protection device is spatially separated from the temperature-sensing element.

8. The battery pack of claim 7, wherein the second protrusion unit is placed over an edge of the second lead adjacent to the protection device.

9. The battery pack of claim 1, wherein the unit cell comprises:
a container having an opening;
an electrode assembly accommodated in the container and comprising i) a first electrode plate having a first polarity, ii) a second electrode plate having a second polarity, and iii) a separator interposed between the first and second electrode plates;
a cap plate configured to substantially seal the opening; and
an electrode pin extending upwards from the cap plate.

10. The battery pack of claim 9, wherein the electrode pin has a first polarity, and wherein the cap plate has a second polarity different from the first polarity.

11. The battery pack of claim 10, further comprising an insulating film interposed between the temperature-sensing element and the cap plate.

12. The battery pack of claim 2, further comprising a metal member interposed between the first lead and the protection circuit module.

13. The battery pack of claim 12, wherein the height of the first protrusion unit is substantially the same as the thickness of the metal member.

14. The battery pack of claim 2, wherein a portion of the first lead is bent so as to have a step difference substantially the same as the height of the first protrusion unit.

15. A battery pack, comprising:
a unit cell including an electrode pin formed over an upper surface of the unit cell;
a protection circuit module electrically connected to the unit cell and placed over the upper surface of the unit cell, wherein the protection circuit module comprises i) a circuit substrate having a hole formed in a location corresponding to the electrode pin and ii) at least one protection device placed over the circuit substrate; and
a temperature-sensing element interposed between the upper surface of the unit cell and the circuit substrate, wherein the temperature-sensing element comprises i) a body unit, ii) a first lead connected to the body unit and the electrode pin, and iii) a second lead connected to the body unit and the protection circuit module,
wherein the circuit substrate comprises a first region and a second region that are provided on both sides of the hole,
wherein the temperature-sensing element is placed in the first region and the protection device is placed in the second region, and
wherein an edge of the first lead is bent towards the circuit substrate.

16. The battery pack of claim 15, wherein a first edge of the first lead is connected to the body unit, and wherein a second edge of the first lead is connected to the circuit substrate.

17. The battery pack of claim 15, wherein a first edge of the second lead is connected to the body unit, and wherein a second edge of the second lead is connected to the electrode pin.

18. The battery pack of claim 17, wherein the second lead comprises a second protrusion unit separating the protection device placed in the first region from a connection surface of the second lead connected to the electrode pin.

19. The battery pack of claim 18, wherein the second edge of the second lead is bent so as to form the second protrusion unit.

20. The battery pack of claim 18, wherein the second protrusion unit is bent towards the circuit substrate.
